(19) United States
(12) Patent Application Publication
(10) Pub. No.: US 2023/0272559 A1
(43) Pub. Date: Aug. 31, 2023

(54) METHOD OF WET SPINNING PRECURSOR FIBERS COMPRISING LIGNIN AND DISSOLVING PULP, AND PRECURSOR FIBERS THEREFROM

(71) Applicant: RISE RESEARCH INSTITUTES OF SWEDEN AB, Borås (SE)

(72) Inventors: Andreas BENGTSSON, Sundbyberg (SE); Maria SEDIN, Solna (SE); Elisabet BRÄNNVALL, Kista (SE); Alice LANDMÉR, Växjö (SE); Fernando ALVARADO, Aveiro (PT)

(21) Appl. No.: 18/003,554

(22) PCT Filed: Jun. 23, 2021
(86) PCT No.: PCT/SE2021/050624

§ 371 Date: Dec. 28, 2022

(30) Foreign Application Priority Data
Jul. 1, 2020 (SE) 2050820-6

(51) Int. Cl. D01F 9/17; D01F 2/00; D01D 5/06; C08L 1/02; C08K 3/22

(52) U.S. Cl. CPC D01F 9/17; D01F 2/00; D01D 5/06; C08L 1/02; C08K 3/22; D10B 2201/22; D10B 2401/063; C08K 2003/2296; C08L 2203/12

(57) ABSTRACT

The present disclosure relates to a method for the production of precursor fiber for the production of carbon fiber, comprising the steps: a) a) forming a spinning dope comprising a dissolving pulp, a lignin and an alkali metal hydroxide dissolved in water (s201); 5 b) extruding the spinning dope through a spinning nozzle to provide a fibrous extrudate (s203); and c) passing the fibrous extrudate through a coagulation liquid to provide the precursor fiber (s205); wherein the coagulation liquid is arranged to effect precipitation of the precursor fiber by regulation of pH and/or ionicity. The disclosure further relates to precursor fibers and carbon fibers produced by the method above, as well as spinning dopes used in the method.

### TECHNICAL FIELD

The present invention relates to methods for the production of precursor fibers for the production of carbon fiber. The present invention further relates to precursor fibers obtained by such a method as well as carbon fibers obtained therefrom.

### BACKGROUND ART

Increasing legislative requirements for improved fuel economy in vehicles is leading to an increased demand for light-weight materials for mass-market vehicle manufacture. Carbon fiber composites could address this demand provided that abundant, lower cost carbon fiber precursors were available.

Carbon fibers are however typically manufactured from polyacrylonitrile (PAN), a precursor material that is both expensive and derived from non-renewable petrochemical sources. The precursor material typically accounts for approximately half of the total cost of carbon fiber, and therefore, due to the high cost of PAN, applications of carbon fibers have typically been limited to specialty applications such as within the aerospace industry and high-end vehicles.

Lignin is an organic polymer present in the support issues of vascular plants. During paper pulping operations, a lignin fraction may be isolated from the pulping process. Lignin is thus an abundant and renewable feedstock. Attempts have been made to utilize lignin as a feedstock in the manufacture of carbon fibers. An overview of such attempts is provided in Baker, D. A., and Rials, T. G. “Recent advances in low-cost carbon fiber manufacture from lignin.”, Journal of Applied Polymer Science, 130(2), 2013, pp. 713-728.

Attempts to produce lignin precursor fibres have most commonly utilized melt spinning techniques; see for example WO 2012/112108 A1. However, this places high demands on the thermal properties of the lignin and thus often requires lignin that has undergone extensive purification or derivatisation in order to be spinnable.

Attempts have also been made to wet spin lignin blends. EP 2889401 B1 discloses a method of wet spinning regenerated cellulose fibers comprising lignin. The method utilises the viscose process which requires the in-situ formation of cellulose xanthate using carbon disulphide.

WO 2012/156441 discloses a method for wet spinning lignin-containing precursor fibers. The fibers are spun from a solution comprising lignin and cellulose or a cellulose derivative in at least one solvent. The solvent is selected from tertiary amine oxides, ionic liquids, polar aprotic solvents, dimethylformamide and/or dimethylacetamide.

There remains a need for an improved method of producing precursor fibres from an abundant source.

### SUMMARY OF THE INVENTION

The inventors of the present invention have identified a number of shortcomings with prior art methods of producing precursor fibers for carbonization. The most commonly applied method, wet spinning of PAN, requires a precursor material that is expensive and from non-renewable sources. Moreover, producing carbon fibers from PAN fibers leads to concurrent production of toxic substances such as NOx and HCN, and therefore necessitates extensive emissions treatment. The production of precursor fibers from lignin commonly utilizes melt spinning, but this however requires lignins that have been subject to extensive purification or derivatisation, thus increasing the cost of the precursor material. The methods that exist for wet spinning lignin blends require either the use of toxic carbon disulphide in the case of the viscose method, or expensive solvents such as ionic liquids in the case of other regenerated celluloses. This increases the environmental impact of the fiber production, as well as the production costs due to the need for complex process equipment.

It is an object of the present invention to provide a method of producing a lignin-containing precursor fiber for the production of carbon fibers that overcomes or at least alleviates one or more of the above shortcomings.

These objects are achieved by a method for the production of precursor fiber according to the appended claims. The method comprises the steps:
a) forming a spinning dope comprising a dissolving pulp, a lignin and an alkali metal hydroxide dissolved in water (s201);
b) extruding the spinning dope through a spinning nozzle to provide a fibrous extrudate (s203); and
c) passing the fibrous extrudate through a first coagulation liquid to provide the precursor fiber (s205);
   wherein the first coagulation liquid is arranged to effect precipitation of the precursor fiber by regulation of pH and/or ionicity.

The method of the invention allows a simple and robust means of spinning of a precursor fiber having significant lignin content using cheap, readily available materials of low toxicity. The method of the invention overcomes or alleviates several of the shortcomings identified in the prior art, and therefore achieves the object of the invention.

The method may be a wet spinning method, i.e. the spinning nozzle may be submerged in the coagulation liquid.

The coagulation liquid may be an aqueous solution of an inorganic acid and/or a salt thereof, preferably an aqueous solution of a mineral acid or a magnesium, calcium, strontium, barium, lithium, sodium, potassium, caesium or ammonium salt thereof. For example, the coagulation liquid may comprise an aqueous solution of sulfuric acid and sodium sulfate; an aqueous solution of sulfuric acid and ammonium dihydrogen phosphate; or an aqueous solution of sulfuric acid, ammonium dihydrogen phosphate and sodium sulfate. Alternatively, the coagulation liquid may comprise an aqueous solution of phosphoric acid and ammonium dihydrogen phosphate. The acidity and/or ionicity of the coagulation bath effects precipitation of the precursor fiber from the dope solution and provides a cohesive fiber structure.

The method may comprise one or more subsequent steps d₁)-dₓ) of washing the precursor fiber in water. This may facilitate drying of the precursor fiber, improve the purity of the obtained precursor fibers, and thus increase the quality of carbon fibers derived from the precursor fibers.

The method may comprise one or more subsequent steps e₁)-eₓ) of applying a spin finish to the precursor fiber, for example by submersing the precursor fiber in an aqueous solution comprising spin finish.

The method may comprise one or more subsequent steps f₁)-fₓ) of drying the precursor fiber, preferably at a temperature of 50° C. or higher, such as from about 50° C. to about 150° C. Drying at these temperatures allows the removal of solvents, including water, without initiating changes at the molecular level of the fiber, such as crosslinking of the lignin.

According to a further aspect of the present invention, the objects of the invention are achieved by a spinning dope according to the appended independent claims. The spinning dope may be used in the method for the production of precursor fiber as described herein.

The spinning dope comprises a dissolving pulp, a lignin and an alkali metal hydroxide dissolved in water.

The dissolving pulp may have an intrinsic viscosity of 200-400 ml/g, preferably 200-300 ml/g. The intrinsic viscosity of the pulp is determined according to the method of ISO 5351:2010. This helps ensure that the dissolving pulp has sufficient solubility in cold alkali and that a spinnable solution results. The dissolving pulp may be from softwood or hardwood, and may be produced by a kraft pulping process or sulphite pulping process. The pulp may optionally have been subjected to a prehydrolysis step and/or an alkaline ozone-bleaching step. For example, the dissolving pulp may be a softwood pulp obtained by a prehydrolysis kraft process.

The lignin may be chosen from LignoBoost lignin, Kraft lignin, soda lignin, organosols lignin, lignin from cellulosic ethanol production, or mixtures thereof, preferably LignoBoost lignin. Since the melt properties of the lignin are non-essential, the lignin may be chosen from a wide variety of commercially available lignins, without requiring further purification. The lignin may for example be a softwood lignin. Alternatively or in addition, it may be a hardwood lignin, a grass lignin, or may comprise a mixture of two or more such lignins.

The spinning dope may further comprise a dope stabilizer selected from zinc oxide, urea and C₂₋₃ polyalkyleneoxide. The dope stabilizer may preferably be zinc oxide. The use of such a dope stabilizer provides spinning dopes that are stable for extended periods at cold (approx. 5° C.) and/or ambient temperatures. The spinning dope may comprise from about 0.5% to about 5% by weight of the dope stabilizer relative to the total weight of the spinning dope, preferably from about 1% to about 2% by weight.

The spinning dope may comprise from about 3% to about 7% by weight of dissolving pulp relative to the total weight of the spinning dope, preferably from about 4% to about 6% by weight. The ratio of dissolving pulp to lignin in the spinning dope may be from about 99:1 to about 1:1 by weight, preferably from about 9:1 to about 1:1 by weight, even more preferably from about 8:2 to about 6:4 by weight. The spinning dope may comprise from about 6% to about 10% by weight of alkali metal hydroxide relative to the total weight of the spinning dope, preferably from about 7% to about 9% by weight. Such properties may assist in providing a precursor fiber having sufficient mechanical properties as well as a suitable lignin loading for carbonization.

According to a further aspect of the present invention, the objects of the invention are achieved by a precursor fiber according to the appended claims.

The precursor fiber may be produced by the method for the production of precursor fiber as herein described.

The precursor fiber comprises a dissolving pulp and a lignin. Features of the method and spinning dope herein described, such as the nature and relative concentrations of the dissolving pulp and lignin, may equally well be applied to the resulting precursor fiber, where appropriate. So, for example, the dissolving pulp may be a softwood kraft pulp, and/or may have intrinsic viscosity of 200-400 ml/g. The lignin may be chosen from LignoBoost lignin, Kraft lignin, soda lignin, organosols lignin, lignin from cellulosic ethanol production, or mixtures thereof, preferably LignoBoost lignin. The ratio of dissolving pulp to lignin in the precursor fiber may be from about 99:1 to about 1:1, preferably from about 9:1 to about 1:1 by weight.

The precursor fiber may comprise from about 50-90% by dry weight of the dissolving pulp and about 10-50% by dry weight of the lignin, relative to the total dry weight of the precursor fiber. The precursor fiber may comprise further elements such as zinc and/or phosphorous. The precursor fiber may comprise from about 500 ppm to about 10000 ppm zinc, preferably from about 500 to about 1000 ppm zinc, and/or from about 500 ppm to about 5000 ppm phosphorus.

The precursor fiber may be striated (i.e. comprise striations) in a longitudinal direction.

The precursor fiber may have a fiber diameter of from about 1 μm to about 100 μm, preferably from about 5 μm to about 50 μm.

According to another aspect of the present invention, the objects of the invention are achieved by a method for the production of carbon fiber according to the appended claims. The method comprises the steps:
a) producing a precursor fiber by the method as described herein;
b) optionally stabilizing the precursor fiber by heating to a temperature of from about 200° C. to about 350° C., preferably from about 200° C. to about 300° C.; and
c) carbonizing the precursor fiber by heating in an inert atmosphere to a temperature of about 900° C. or higher.

The method thus allows for the production of carbon fibers from a precursor fiber that is simple and relatively environmentally benign to produce, from precursor materials that are cheap, renewable, abundant and non-toxic.

The stabilizing step may be performed in an oxidizing or in an inert atmosphere. If the stabilizing step is performed in an inert atmosphere, the stabilizing and carbonizing steps may be performed as a single operation.

According to yet a further aspect of the present invention, the objects of the invention are achieved by a carbon fiber produced by the method for the production of carbon fiber described herein.

The carbon fiber may have a radiocarbon age of less than 10 000 years before present, preferably less than 1000 years before present, even more preferably less than 100 years before present. That is to say that the carbon fiber is derived from substantially renewable resources. The carbon fiber may comprise more than 85% by weight carbon, preferably more than 90% by weight carbon. The carbon fiber may comprise phosphorus in up to 2% by weight. The carbon fiber may comprise longitudinal striations.

Further objects, advantages and novel features of the present invention will become apparent to one skilled in the art from the following detailed description.

### BRIEF DESCRIPTION OF THE DRAWINGS

For a fuller understanding of the present invention and further objects and advantages of it, the detailed description set out below should be read together with the accompanying drawings, in which the same reference notations denote similar items in the various diagrams, and in which:

FIG. 1a schematically illustrates an apparatus for wet spinning of a precursor fiber

FIG. 1b schematically illustrates an apparatus for dry jet wet spinning of a precursor fiber

FIG. 2 is a flow chart schematically illustrating a method for the production of a precursor fiber

FIG. 3 is a collection of SEM images of precursor fibers prepared using a variety of dopes

FIG. 4 is a collection of SEM images of carbon fibers prepared from precursor fibers prepared using a variety of dopes.

### DETAILED DESCRIPTION

The present invention provides a simple, robust and non-toxic method of producing precursor fiber for the production of carbon fiber from renewable sources. By renewable it is meant a material derived from a natural resource that, after exploitation, can return to its previous stock levels by natural processes of growth or replenishment.

The method comprises the following steps:
a) forming a spinning dope comprising a dissolving pulp, a lignin and an alkali metal hydroxide dissolved in water (s201);
b) extruding the spinning dope through a spinning nozzle to provide a fibrous extrudate (s203); and
c) passing the fibrous extrudate through a coagulation liquid to provide the precursor fiber (s205).

The coagulation liquid is arranged to effect precipitation of the precursor fiber by regulation of pH and/or ionicity. The precipitated fiber may then be treated in further process operations such as stretching, washing and drying to provide a final precursor fiber.

Materials

The spinning dope comprises a lignin, dissolving pulp and an alkali metal hydroxide dissolved in water.

Lignin

Lignin is an amorphous polyphenolic material created through the enzymatic polymerisation of coniferyl-, sinapyl- and p-coumaryl-alcohols in lignocellulosic materials such as wood. The lignin for use in the present invention may be obtained from any lignocellulosic source material. These include wood, annual crops and agricultural waste.

Suitable woods may include softwoods and hardwoods. The softwood tree species can be for example, but are not limited to: spruce, pine, fir, larch, cedar, and hemlock. Examples of hardwood species from which lignin suitable as a starting material in the present invention may be derived include, but are not limited to: birch, oak, poplar, beech, eucalyptus, acacia, maple, alder, aspen, gum trees and gmelina. The raw material for lignin production may comprise a mixture of different softwoods, e.g. pine and spruce. The raw material may also comprise a non-wood raw material, such as bamboo, sugar beet pulp, wheat straw, soy hulls, corn stover, bagasse and grasses such as switchgrass and elephant grass.

Since the lignin can be produced from various green resources, such as wood, agricultural residues and annual crops, it is thus abundant, renewable and biodegradable.

The lignin may be isolated as a by-product of a pulping process for the manufacture of paper or board. Common pulping processes are the kraft (sulphate) process, soda process and organosols processes that may utilize a variety of solvents including but not limited to ethanol, methanol, butanol, ethylene glycol, acetic acid, formic acid, acetone and mixtures thereof. The lignin may be obtained from a LignoBoost process whereby high-quality lignin is obtained by at least partially neutralising kraft black liquor using carbon dioxide in order to precipitate the lignin. The LignoBoost process is further described in: Tomani, Per; The LignoBoost Process; Cellulose Chem Technol., 44(1-3), 53-58 (2010).

The lignin may be isolated as a by-product of cellulosic ethanol production. When fermenting a lignocellulosic biomass feedstock to produce ethanol, typically 15 to 30 percent of the biomass remains unconverted after fermentation. This residual biomass comprises primarily lignin.

The lignin used in the present invention is preferably non derivatised lignin. By non-derivatised lignin it is meant lignin that is not subject to any extensive derivatisation either during isolation or through post-isolation modification. Non-derivatised lignins may be subject to some degree of hydrolysis or oxidation during isolation, depending on the process used for isolating the lignin, but this is an unintentional consequence of the isolation process and the primary lignin structure remains substantially intact and unmodified. For example, lignins isolated by the kraft and soda pulping processes are considered to be non-derivatised. Lignosulfonates isolated as a by-product of the sulphite pulping process are not considered to be a non-derivatised due to the abundance of sulfonate groups formed on the lignin primary structure. Organosolv lignins may or may not be considered non-derivatised depending on the extent of derivatisation (e.g. acetylation) occurring during isolation.

The lignins used may be fractionated by any means known in the art, e.g. ultrafiltration or precipitation, in order to provide a purer lignin or a lignin with reduced dispersity.

The lignin is preferably provided in pulverized form for use in the methods of the invention.

Dissolving pulp Dissolving pulp is a cellulose pulp having high cellulose content and low hemicellulose content. The dissolving pulp may have a cellulose content of greater than 80% by dry weight, preferably greater than 90% by dry weight. Dissolving pulps are typically bleached and typically have a relatively uniform molecular-weight distribution. The term dissolving pulp arises because the pulp is typically dissolved into a solvent, either directly or by derivatisation, in order to provide a homogenous solution suitable for further processing. In the present case, the dissolving pulp is directly soluble in alkali solution without derivatisation. In this manner it differs from dissolving pulp used e.g. in the viscose process, which requires derivatisation into a xanthate (xanthation) using toxic carbon disulphide in order to be rendered soluble in aqueous alkali.

The dissolving pulp may be a softwood or hardwood pulp. The softwood tree species can be for example, but are not limited to: spruce, pine, fir, larch, cedar, and hemlock. Examples of hardwood species from which pulp suitable as a starting material in the present invention may be derived include, but are not limited to: birch, oak, poplar, beech, eucalyptus, acacia, maple, alder, aspen, gum trees and gmelina. The raw material for pulp production may comprise a mixture of different softwoods, e.g. pine and spruce. The raw material may also comprise a non-wood raw material, such as bamboo, sugar beet pulp, wheat straw, soy hulls, corn stover, bagasse and grasses such as switchgrass and elephant grass. The raw material may also consist of or comprise recycled cotton.

Since the pulp can be produced from various green resources, such as wood, agricultural residues and annual crops, as well as from recycled cotton, it is thus abundant, renewable and biodegradable.

The dissolving pulp may be produced by any suitable pulping process, such as a sulfate (kraft), soda or sulphite pulping process. For example, the dissolving pulp may be produced in a sulfate process with prehydrolysis, followed with one or more bleaching steps. A suitable process is described in WO2016080895 A1, which is incorporated herein by reference.

The dissolving pulp may have an intrinsic viscosity of 200-400 ml/g, as determined according to the method of ISO 5351:2010. Preferably, the intrinsic viscosity is from about 200 to about 300 ml/g. Such pulps are soluble in alkaline solution at a concentration of approximately 4-6% by weight. For comparison, typical commercial dissolving pulps have an intrinsic viscosity of greater than 450 ml/g and are incapable without derivatisation of dissolving cellulose in suitable concentrations in aqueous alkali for spinning.

Since dissolving pulp is typically derived from a lignocellulosic feedstock, it may commonly comprise some residual native lignin, such as less than 0.5 wt % lignin or less than 0.3 wt % lignin. To avoid any ambiguity, it is stated that the spinning dope must comprise added lignin, that is to say not merely lignin residual in the dissolving pulp.

Dope Stabilizer

Further additives may be added to the spinning dope, for example in order to improve the stability of the dope and/or improve the properties of the resulting fiber. For example, it has been found that addition of a dope stabilizer in suitable quantities, such as zinc oxide, urea or polyalkylene oxide (e.g. PEG, PEO, or PPG), improves the stability and spinnability of the dope.

Coagulation Liquid

The coagulation liquid is a liquid capable of effecting precipitation of the precursor fiber from the extruded dope by control of pH and/or ionicity, i.e. by controlling pH, by controlling iconicity, or by controlling both pH and ionicity. The coagulation liquid typically comprises an acid and a corresponding salt of the acid, although mixed acid/salt pairs may also be utilized. The coagulation liquid may be an aqueous solution of an inorganic acid and/or a salt thereof, preferably an aqueous solution of a mineral acid or a magnesium, calcium, strontium, barium, lithium, sodium, potassium, caesium or ammonium salt thereof. One such coagulation bath is an aqueous solution of sulphuric acid (e.g. 5-20 wt %, such as 10 wt %) and optionally sodium sulfate (e.g. 0-20 wt %, preferably 10-20 wt %, such as 12-15 wt %). Another coagulation bath successfully used is an aqueous solution of phosphoric acid (e.g. 5-20 wt %, such as 5-12.5 wt %) and optionally ammonium dihydrogen phosphate (e.g. 0-20 wt %, such as 2.5-10 wt %). A bath comprising sulphuric acid with ammonium dihydrogen phosphate may also be utilized. A bath comprising diammonium hydrogen phosphate (e.g. 2.5-20 wt %), optionally together with an acid (e.g. sulphuric acid or phosphoric acid) may be used. It has been found that using phosphorus-containing precipitation baths ultimately results in obtaining carbon fibers in higher yield, and the resulting carbon fibers have superior mechanical properties.

Method

Preparation of the Spinning Dope

The dope is preferably prepared by forming an alkali solution of dissolving pulp, and then dissolving the lignin in this solution. The dope may be prepared by first swelling the dissolving pulp in aqueous alkali for a period. Further alkali, water, and optionally a dope stabilizer are added to the mixture, and the mixture is stirred to a homogenous solution at low (sub-zero) temperature. Cellulose has maximum solubility in alkaline solution at such temperatures. Once a homogenous solution is obtained, the solution may be filtered and degassed prior to addition of lignin. Alternatively, lignin may be added prior to filtration and degassing, or even directly after swelling of the dissolving pulp, in conjunction with dilution and addition of other additives. The lignin may be added directly to the dope as a powder or may be dissolved in alkali solution prior to addition. After all components of the spinning dope have been added and dissolved, the dope is preferably filtered and degassed prior to use. Once formed, the dope may be stored for extended periods (e.g. 1 week) under refrigeration (4° C.) or at ambient temperature (22° C.), depending on the exact composition of the dope.

Spinning

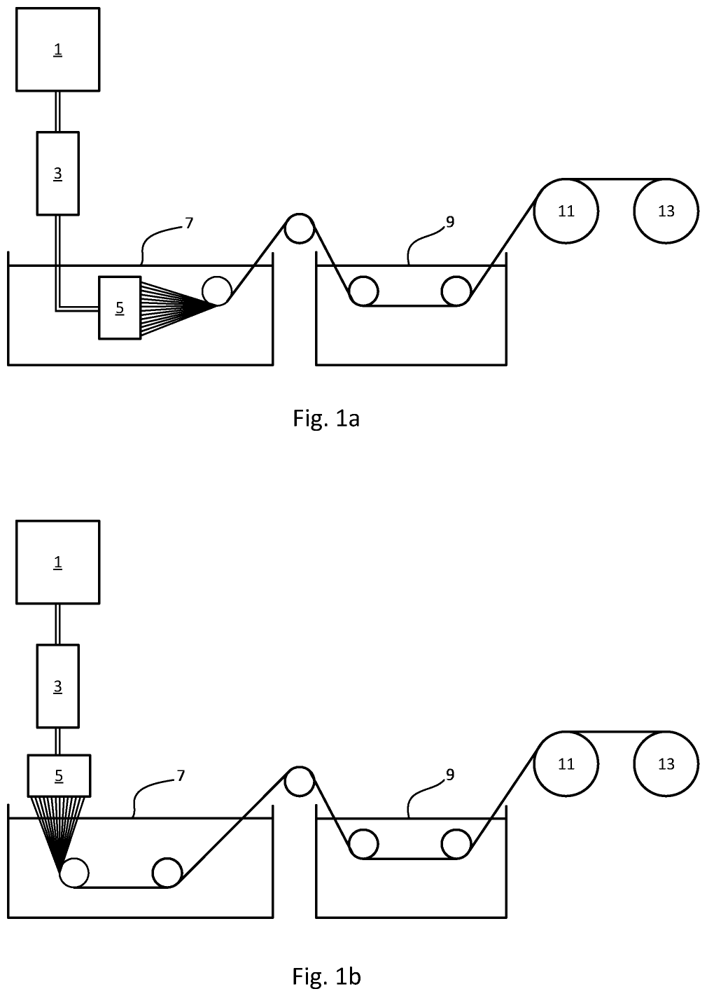

An apparatus for wet spinning of the precursor fiber from the spinning dope is schematically illustrated in FIG. 1a, and an apparatus for dry jet wet spinning of the precursor fiber is illustrated in FIG. 1b. The precursor fibers are preferably produced by a method for wet spinning. Dry jet wet spinning typically requires dopes having a higher viscosity than dopes for wet spinning.

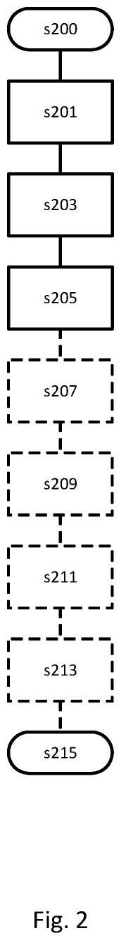

A flow chart depicting the process for producing the precursor fiber is shown in FIG. 2.

Step s200 denotes the start of the process. In a step s201 a spinning dope as described above is provided. The spinning dope is held in a dope tank 1. The dope is then extruded through the spinning nozzle 5 in a step s203 using a metering pump 3. The produced fibrous (i.e. fiber-shaped) extrudate is then in a step s205 submerged in at least one coagulation bath 7. In wet spinning (FIG. 1a) the spinneret is submerged in the coagulation bath such that the fibrous extrudate is immediately contacted with the coagulation liquid upon extrusion from the spinneret, whereas in dry jet wet spinning (FIG. 1b) the spinneret is non-submerged and the fibrous extrudate must first pass through a gap prior to submersion in the coagulation bath. After the step s205, the produced fiber may be washed in a step s207 in one or more washing baths 9. Spin finish may be applied to the fiber in a step s 209. The fiber may then subsequently be dried in a step s211 on a dryer roll 11, and collected in a step s213 on a collection reel 13. Step s215 denotes the end of the process.

In order to spin fiber the spinning dope is extruded through a spinning nozzle such as a spinneret. The spinneret may be of the monofilament type or the multifilament type, and may comprise orifices of any suitable diameter, such as about 5 μm to about 100 μm. Suitable process parameters such as flow rate may be determined by a person skilled in the art. After leaving the spinning nozzle the fibrous extrudate is passed through a coagulation bath comprising the coagulation liquid. Depending on the spinning technique utilized the spinning nozzle may extrude directly into the coagulation liquid, i.e. wet spinning, or the spinning nozzle may first extrude to an intermediate gaseous phase, such as air or an inert gas, prior to the fibrous extrudate being submerged in the coagulation liquid. This is known as dry jet wet spinning and is also known as air-gap wet spinning. Any suitable apparatus known in the art may be used for spinning the precursor fibers.

Precipitation of the fiber from the extrudate is typically effected by passing through a single coagulation liquid as described above. However, precipitation/coagulation may also be effected in several stages by passing through a series of coagulation liquids, such as a first coagulation liquid and a second coagulation liquid. This may for example assist in preventing clogging of the spinning nozzle. In such a case, the series of coagulation liquids may be the same, or may be different. For example, the series of coagulation liquids may utilize the same acid and/or salt, but in different concentrations. For example, the second coagulation liquid may have a higher acid and/or salt concentration than the first coagulation bath. The series of coagulation liquids may also differ, such that for example the first coagulation bath utilizes a salt and the second coagulation bath utilizes an acid.

After precipitation, the formed precursor fiber may be subjected to further operations known in the art, such as stretching, washing and drying. Stretching may for example be achieved by control of the extrusion rate relative to the rotation rate of the collection roller. Stretching may increase the alignment of the spun fibers and improve the mechanical strength and properties of the stretched fiber.

The precursor fiber may be washed by submersion in one or more baths. The washing solution may comprise or consist of water, or may comprise or consist of further components, such as an organic solvent. Water may assist in removing residual salts from the fiber. The washing liquid may be heated somewhat to a suitable temperature below the boiling point of the washing liquid in order to improve diffusion of the washing liquid into the fiber as well as increase the solubility of any impurities in the washing liquid.

After washing, spin finish may be applied to the fiber. The application of spin finish may facilitate further processing of the fiber, for example by lubricating the fiber, reducing build-up of static or by improving fiber cohesion. Suitable spin finishes are known in the art. The spin finish is typically applied by spraying or by submersion of the precursor fiber in a bath comprising the spin finish.

The fiber may be dried by any means known in the art, for example by drying around a heated roller. Suitable drying temperatures may be in excess of 50° C., such as from about 50° C. to about 150° C. Excessive drying temperatures may inadvertently initiate crosslinking of the lignin in the fiber.

Precursor Fiber

The precursor fiber obtained from the method above comprises dissolving pulp and lignin. The precursor fiber may have a ratio of dissolving pulp to lignin of from about 99:1 to about 1:1 by dry weight, preferably from about 9:1 to about 1:1 by dry weight.

The precursor fiber may comprise further substances that are utilized in the spinning process. For example, although much of the dope stabilizer is lost during coagulation and washing, a fraction of the dope stabilizer may be trapped in the fiber during fiber formation and be found in the precursor fiber. For example, the precursor fiber may comprise greater than 500 ppm (by weight) zinc, such as from about 500 ppm to about 10000 ppm, obtained when e.g. zinc oxide is used as the dope stabilizer. If the coagulation bath comprises phosphorus, the precursor fiber may comprise greater than 500 ppm (by weight) phosphorus, such as from about 500 ppm to about 5000 ppm.

The obtained precursor fibers may have a fiber diameter of from about 1 μm to about 100 μm, preferably from about 5 μm to about 50 μm. The obtained precursor fibers may have a linear density (titer) of from about 2 to about 8 dtex, such as about 4 to about 8 dtex.

The obtained precursor fibers may have longitudinal striations.

The obtained precursor fibers are continuous, i.e. they may be spun in long lengths without breakage, e.g. lengths in excess of 1 meter. Fibers that are flexible, non-tack and having good wet- and dry strength may be obtained by the method above.

Although termed herein as a “precursor fiber”, the fiber obtained from the method above may have applications in other fields besides the manufacture of carbon fiber. For example, the fibers obtained may be woven and/or used in new composite materials, such as continuous fiber composites. Depending on the porosity of the fibers, they may be used in filtration or purification applications, either with or without subsequent carbonization.

Carbon Fiber

The precursor fibers may be further converted to carbon fibers using techniques known in the art. Such techniques may be continuous or batch-wise. Batch-wise conversion typically involves stabilizing the precursor fibers by heating in an oxidative atmosphere for a predetermined time, prior to carbonizing the stabilized fibers in an inert atmosphere at higher temperatures. For example, the stabilization may be performed in air using a temperature ramp of 0.1-10° C./min from ambient temperature up to a temperature of from about 200° C. to about 350° C., such as from about 200° C. to about 300° C., such as about 250° C., followed by maintaining the stabilization temperature for a predetermined period. Although typically performed in air, the precursor fibers are not thermoplastic and therefore may be stabilized in inert atmosphere. In such a case, the stabilization and carbonization steps may be performed as a single operation. Following stabilization, the stabilized fibers may be carbonized under an inert atmosphere, such as under nitrogen or argon, using a temperature ramp of from about 1° C./min to about 20° C./min up to a temperature of about 900° C. or higher, such as about 1000° C.

The precursor fibers obtained by the method above may be converted to carbon fibers in this fashion.

The carbon fibers consist of greater than 80% by weight carbon, preferably greater than 86% by weight carbon, such as from about 87% to about 95% by weight carbon. If the precursor fiber comprises phosphorus, this may be conserved to some degree in the carbon fiber, and the carbon fibers may comprise from about 0.5% to about 2% by weight phosphorus.

The carbon fibers may comprise longitudinal striations, which are conserved from the precursor fiber. Such longitudinal striations may be of benefit when the carbon fibers are used in composite materials in order to assist in adhesion to the matrix material.

Carbon derived from fossil resources typically has a radiocarbon age of in excess of 35 000 years, whereas carbon derived from renewable sources is found to be “modern”. The polyacrylonitrile (PAN) precursor fiber typically utilized in the manufacture of carbon fibers is fossil-derived, and therefore the carbon fibers obtained from PAN will typically have a radiocarbon age of 35 000 years or older. In contrast, the present carbon fibers are derived from renewable resources only, and therefore will be determined to be “modern” using radiocarbon dating techniques. That is to say, that carbon fiber obtained by the methods described herein will have a radiocarbon age of less than 10 000 years before present, preferably less than 1 000 years, such as less than 100 years before present. Methods of radiocarbon dating carbonaceous objects are known in the art.

### EXAMPLES

Spinning Dope

The following materials were used for spinning precursor fibers:

Lignin (softwood kraft lignin, SKL) produced using the LignoBoost process was obtained from LignoDemo, Bäckhammar, Sweden.

A conventional prehydrolysed softwood kraft pulp was converted to dissolving pulp having an intrinsic viscosity 260 ml/g using the bleaching method as disclosed in WO2016080895A1. The resulting dissolving pulp has an intrinsic viscosity of 260 ml/g and is soluble in cold alkali. All other materials were obtained from commercial suppliers and were used as received.

The dissolving pulp (10 wt. %) was swelled overnight in an aqueous system with 5 wt. % NaOH. Thereafter, a mixture of deionized (D.I.) water, ZnO, and NaOH was added to the system adjusting the concentrations to 5.5 wt. % cellulose, 8 wt. % NaOH, 1.5 wt. % ZnO and water. Dissolution of the cellulose fibres was then achieved after mixing at 60 RPM in a container with baffles cooled by a radiator according to a temperature profile of −10° C. for 8 min, increased to −5° C. for 12 min, and finally −0.5° C. for 12 min. Successful dissolution was confirmed by observation of the dope in a light microscope. Filtration of the cellulose dope was done with a 70 μm sintered metal filter using nitrogen gas. Subsequently, dope deareation was done by centrifugation at 5000 RPM for 15 min.

Lignin was added in powder form to the cellulose dope while stirring by hand with a spatula. The quantity of dissolving pulp was held constant while added lignin varied depending of sought pulp/lignin ratio. Deareation of the final dope was done at a pressure below 3.5 kPa for 3 h, whilst cooling the solution in an ice bath.

A total of 8 dopes were prepared, varying in absolute cellulose conc. (4.5 wt % to 5.5 wt. %) and total dope (pulp+lignin) concentration (4.5 to 9.2 wt. %).

The prepared dopes are shown in Table 1 below

TABLE 1

| Pulp (wt. %) | Lignin (wt. %) | Pulp/Lignin | Total conc. (wt %) |
|---|---|---|---|
| 4.5 | 0.1 | 100/0 | 4.5 |
| 4.5 | 1.9 | 70/30 | 6.4* |
| 4.5 | 2.4 | 65/35 | 6.9* |
| 5.5 | 0.0 | 100/0 | 5.5 |
| 5.5 | 0.6 | 90/10 | 6.1 |
| 5.5 | 1.4 | 80/20 | 6.9 |
| 5.5 | 2.4 | 70/30 | 7.9** |
| 5.5 | 3.7 | 60/40 | 9.2* |

Dopes marked * were filtered (32 μm) after addition of lignin. Dopes marked ** were tested both with and without filtration (32 μm) after addition of lignin.

The dopes were found to be stable in refrigerated condition for up to two weeks, although a certain change in appearance and gel formation could be noted for dopes having high lignin content (70/30 pulp/lignin or greater). At ambient temperature, the dopes were storage stable at lignin concentrations of up to 80/20 pulp/lignin.

Wet Spinning

The dope was stored at 4° C. until the start of each spinning trial. A 50 ml dope tank syringe was used allied to a gear pump feeding the dope at a flow rate of 1 ml/min to a nozzle with a multifilament spinneret (100 holes, Ø100 μm). A typical wet spinning setup was used, as schematically illustrated in FIG. 1a.

The coagulation bath used in the experiments presented here consists of water, 10 wt. % H₂SO₄ and 15 wt. % Na₂SO₄.

Two wash bath setups were tested, one utilizing a single wash bath of deionized water followed by a wash bath comprising spin finish in deionized water (denoted 1+1), and another utilizing three wash baths of deionized water followed by a wash bath comprising spin finish in deionized water (denoted 3+1). The spin finish used was Neutral®, Unilever, Copenhagen, Denmark.

Table 2 below outlines the spinning trials performed, wherein+denotes a successful spinning, —denotes an unsuccessful spinning, and N/A denotes no trial performed. The following terminology is used to denote the dope used. C5.5-L10 denotes a dope having 5.5 wt % dissolving pulp (cellulose) and a pulp/lignin ratio of 90/10.

TABLE 2

| | Filtration (70 μm) prior to | | Filtration (32 μm) after | |
|---|---|---|---|---|
| | addition of lignin | | addition of lignin | |
| Dope | 1 + 1 baths | 3 + 1 baths | 1 + 1 baths | 3 + 1 baths |
| C5.5 − L0 | + | + | N/A | N/A |
| C5.5 − L10 | + | + | N/A | N/A |
| C5.5 − L20 | + | + | N/A | N/A |
| C5.5 − L30 | + | + | + | + |
| C5.5 − L40 | − | − | + | N/A |
| C4.5 − L0 | + | + | N/A | N/A |
| C4.5 − L30 | N/A | N/A | + | + |
| C4.5 − L35 | N/A | N/A | + | + |

Additional experiments using C4.5-L30 spinning dope have been done with a decrease of Na₂SO₄ to 12.1 wt. % (successful spinning) and 7.5 wt. % (unsuccessful spinning).

Yet another coagulation bath system consisting of H₃PO₄ and ammonium dihydrogen phosphate [(NH₄)(H2PO₄) ADHP] in water has been investigated. Phosphorus acts as a flame retardant in conversion to carbon fibre. 12.5 wt. % H₃PO₄ and 10 wt. % ADHP; and 5 wt. % H₃PO₄ and 6.4 wt. % ADHP gave successful spinning using C4.5-L30 spinning dope.

Precursor Fibers

The resulting precursor fibers have a linear density ranging from approximately 2 dTex to approximately 10 dTex, with an average linear density of about 6.4 dTex.

The tensile strengths of the fibers obtained range from approximately 5 cN/Tex to approximately 30 cN/Tex, and the tensile modulus ranges from approximately 400 cN/Tex to about 1500 cN/Tex. Higher proportions of lignin in the fiber seem to decrease both tensile modulus and strength. Filtration of the dope subsequent to lignin dissolution appears to improve the mechanical properties of the obtained fibers, as does increasing the residence time in the wash bath by having a larger number of wash baths. However, it should be noted that all spun precursor fibers are sufficiently strong for non-problematic further processing.

Three different precursor fibers were selected for further characterisation and processing into carbon fibers. These three precursor fibers were spun using the dopes as shown in Table 3 below, and spun using conditions as described below.

TABLE 3

| | | Lignin/pulp | Pulp dope | Lignin dope | |
|---|---|---|---|---|---|
| | | dope ratio | conc. | conc. | |
| Example | Sample | (w/w) | (wt %) | (wt %) | Coagulation bath |
| 1 | 100C | 0/100 | 5.5 | 0 | 10 wt % H2SO4 + |
| | | | | | 15 wt % Na2SO4 |
| 2 | 3070LC | 30/70 | 5.5 | 2.4 | 10 wt % H2SO4 + |
| | | | | | 15 wt % Na2SO4 |
| 3 | 3070LC-P | 30/70 | 4.5 | 1.9 | 10 wt % [NH4][H2PO4] + |
| | | | | | 12.5 wt % H3PO4 |

Each of these precursor fibers were prepared using the following conditions. All dopes were prepared by dissolution in cold NaOH (8 wt %) and by using ZnO (1.5 wt % relative to the total dope weight) as a dope stabilizing additive. Prior to wet spinning, the dopes were filtrated through a sintered metal filter (76 μm) and deaerated for 2-3 h at reduced pressure (3.5 kPa). The spinneret used for wet spinning comprised 100 holes @ 100 μm/hole. Different cellulose concentrations and coagulation baths were used, as per the Table above. Stretching and washing during fibre spinning was with performed in deionized water. A spin finish was applied in the last washing bath prior to drying. Fibres were dried at 80-90° C. before winding. The precursor fibres were conditioned at 23° C. and 30±3% RH for at least 48 h prior to analysis and conversion into carbon fiber.

The obtained precursor fibers have composition and characteristics as outlined in Tables 4 and 5 below.

TABLE 4

| | | Titer | Ash content | E-modulus | | Tensile strength | Elongation at break |
|---|---|---|---|---|---|---|---|
| Example | Sample | (dtex) | (wt %) | (cN/tex) | | (cN/tex) | (%) |
| 1 | 100C | 2.0 | 0.6 | 1434 | (147) | 26 (1.6) | 4.9 (0.6) |
| 2 | 3070LC | 6.8 | 1.3 | 665 | (43) | 12 (0.9) | 6.6 (1.9) |
| 3 | 3070LC-P | 5.7 | 4.2 | 999 | (53) | 15 (1.8) | 2.8 (0.9) |

The ash content was determined according to ISO 1762 in a thermogravimetric analyser (TGA) under air at 525° C. (TA Instruments Q5000 IR, New Castle, Del., USA).

Single fibre tensile testing was performed on conditioned precursor fibers (23±2° C. and 30±3% relative humidity (RH)) on a LEX820/LDS0200 fibre dimensional system (Dia-Stron Ltd., Hampshire, UK). The precursor fibers were measured at a fixed gauge length of 20 mm using an elongation speed of 5 mm min′. The reported values are the average of 25-35 measurements.

It is seen that the tensile properties of the precursor fibers are higher than for melt spun lignin fibres. Improved tensile properties are beneficial e.g. for handleability and processability in carbon fiber conversion.

TABLE 5

| | | | Amount (mg/kg) | | | | | |
|---|---|---|---|---|---|---|---|---|
| Example | Sample | Ash (wt %) | Ca | K | Na | P | S | Zn |
| 1 | 100C | 0.6 | 329 | 640 | 7960 | n.d. | 6440 | 450 |
| 2* | 3070LC* | 4.6 | 101 | n.d. | 17200 | n.d. | 22100 | 830 |
| 3 | 3070LC-P | 5.7 | 48 | n.d. | 585 | 3260 | 4770 | 950 |

Example 2* (3070LC*) is similar, but not identical, to the precursor fiber of Example 2 (3070LC).

Elemental composition of the precursor fibers was determined by inductively coupled plasma optical emission spectroscopy (ICP-OES; PerkinElmer Optima 8300, U.S.A.). Prior to analysis, 25-50 mg of precursor fiber was oxidized in a Teflon vessel using 2-7 mL of deionized water and 2 mL of 30 vol % hydrogen peroxide which was allowed to react for 10 min. Subsequently, 5 mL of concentrated nitric acid was added and then wet-digested in a microwave digestion system (ETHOS One, Milestone S.r.L., Italy) at 180° C. for 15 min.

Zinc is present in all precursor fibers, with more zinc in the lignin-containing precursor fibers, which may be due to a higher affinity of zinc to lignin, or may be due to the larger fibre diameter of the precursor fibers containing lignin.

As expected, phosphorus is present only in 3070LC-P, i.e. the precursor fiber prepared by coagulation in a phosphoric acid and ADHP. Sodium and sulfur are present in all precursor fibers, indicating that at least some of the sodium and sulfur content originates from the starting materials. As expected, the sodium and sulfur content is higher in fibers prepared by coagulation in the Na₂SO₄/H₂SO₄ bath, as compared to those prepared by coagulation in a bath lacking these elements.

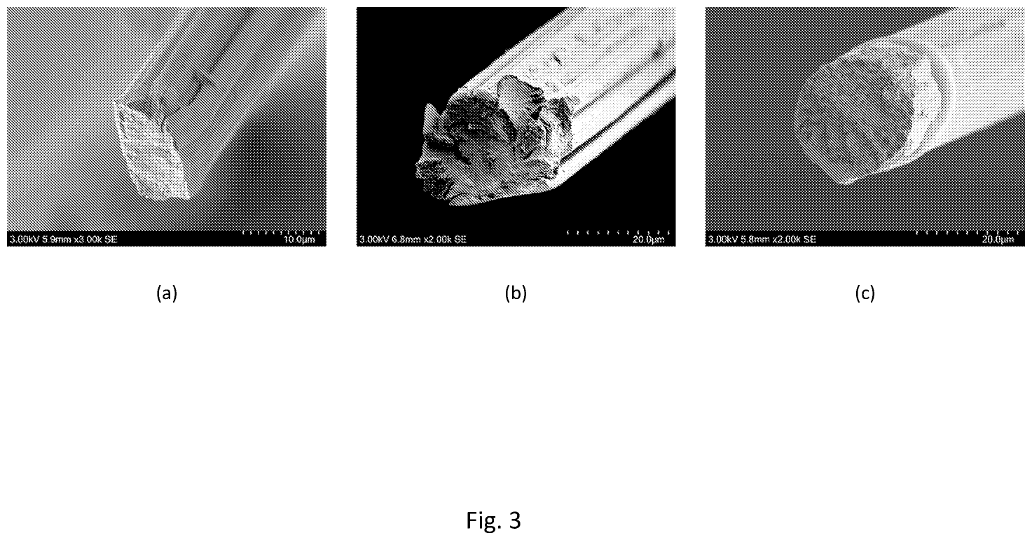

SEM images of the obtained precursor fibers are shown in FIG. 3. Image (a) is of Example 1 (100C), image (b) is of Example 2 (3070LC) and imager (c) is of Example 3 (3070LC-P).

A Hitachi SU3500 scanning electron microscope (SEM) operating with a secondary electron (SE) detector and an acceleration voltage of 3 kV was used to study the morphology of the precursor fibers. Prior to analysis, the precursor fibers were Ag-coated by a 108 auto sputter coater (Cressington Scientific Instruments Ltd., UK) and then placed on a sample holder using double-sided carbon tape. Cross-sections were prepared by snapping the carbon fibers with a scalpel in liquid nitrogen.

The precursor fibers have longitudinal striations, which are conserved in the carbon fibers (see below). This is beneficial for the adhesion to the matrix in a composite. Surprisingly, the striations are more pronounced in 100C and 3070LC compared to 3070LC-P. This is likely related to a difference in the coagulation behaviour due to the different compositions of the coagulation baths. The cross sections of the precursor fibers are solid, and the precursor fiber morphology is oval to circular. 3070LC-P (Example 3) is more circular than the other two. Stretch ratio and drying conditions likely affect the morphology of the precursor fiber.

Carbon Fibers

A sample of each of the precursor fibers was converted to carbon fibers by the following procedure. The precursor fibers were fixed on graphite bridges (Gerken Nordiska Karma, Jarfalla, Sweden) to prevent fibre shrinkage during conversion into carbon fiber. The fixated precursor fibers were stabilised in a muffle furnace (KSL-1200X, MTI Corporation, Richmond, Calif., USA) using air (7 L/min) and a heating rate of 1° C./min from 25 to 250° C. at which they were held for 60 min, giving a total stabilisation time of 285 min. Carbonisation was carried out in a tube furnace (Model ETF 70/18, Entech, Angelholm, Sweden) using a nitrogen flow (200 mL/min) by heating from 25 to 1000° C. at 3° C./min.

The obtained carbon fibers have composition and characteristics as outlined in the Tables 6-8 below.

TABLE 6

| | | Carbon | Oxygen | Sulphur | Zinc | Phosphorous |
|---|---|---|---|---|---|---|
| Example | Sample | (wt %) | (wt %) | (wt %) | (wt %) | (wt %) |
| 1 | 100C | 85 | 14 | 0 | n.d. | n.d. |
| 2 | 3070LC | 87 | 12 | 1 | n.d. | n.d. |
| 3 | 3070LC-P | 92 | 6 | <1 | n.d. | 1 |

Elemental composition (wt %) of the carbon fibers was estimated by energy dispersive X-ray analysis (SEM-EDXA) (XFlash detector, Bruker Corp., USA) using a BSE detector at a working distance of 10 mm and acceleration voltage of 15 kV. Data evaluation was performed with Esprit v. 1.9.3. software (Bruker Corp., USA).

No zinc is detected in the carbon fibers. Without wishing to be bound by theory, it is thought that this may be because zinc leaves as ZnSO₄ during carbonisation. In the carbon fibers prepared from 3070LC-P (Example 3), 1 wt % of phosphorus is detected. The carbon content is also significantly higher in the carbon fibers prepared from 3070LC-P.

TABLE 7

| | | Stabilisation | Carbonisation | Total conversion |
|---|---|---|---|---|
| Example | Sample | yield (wt %) | yield (wt %) | yield (wt %) |
| 1 | 100C | 98 | 12 | 12 |
| 2 | 3070LC | 94 | 30 | 28 |
| 3 | 3070LC-P | 72 | 49 | 35 |

The gravimetric carbon fiber yield was determined using 36±4 mg of precursor fiber that was placed in ceramic ships and then subjected to stabilization and carbonization. The reported data are normalized to its dry content.

The conversion yield is increased by preparing carbon fibers from lignin-cellulose precursors, as can be observed by comparing 3070LC with 100C (Examples 2 and 1). Maximising the conversion yield is important as the carbon fiber manufacturing process is energy intensive and costly. A further increase in the yield is obtained for the precursor fibers containing phosphorous. Without wishing to be bound by theory, it is thought that ammonium dihydrogen phosphate acts as a flame retardant during conversion and promotes the favourable dehydration reactions during the thermal treatments, i.e. promotes charring. As can be seen, the stabilisation yield is lower for 3070LC-P, due to a more efficient stabilisation, while the carbonisation yield increases substantially. This gives a higher total conversion yield, which is beneficial from an economical aspect.

TABLE 8

| | | | E- | Tensile | Strain |
|---|---|---|---|---|---|
| Exam- | | Diameter | modulus | strength | at break |
| ple | Sample | (μm) | (GPa) | (GPa) | (%) |
| 1 | 100C | 6.0 (0.8) | 71 (15) | 1.17 (0.29) | 1.70 (0.30) |
| 2 | 3070LC | 13.1 (0.8) | 51 (6) | 0.67 (0.12) | 1.31 (0.19) |
| 3 | 3070LC-P | 14.5 (0.9) | 61 (6) | 0.85 (0.19) | 1.41 (0.26) |

Single fibre tensile testing was performed on a LEX820/LDS0200 fibre dimensional system (Dia-Stron Ltd., Hampshire, UK). The carbon fibers were measured at a fixed gauge length of 20 mm using an elongation speed of 0.6 mm min′. The reported values are the average of 30-40 measurements. The carbon fiber diameter was determined by a laser diffraction system for diameter determination (CERSA-MCI, Cabriès, France).

It is found that carbon fiber from 100C has the highest tensile properties, followed by 3070LC-P. However, it is well known that a smaller carbon fiber diameter greatly influences the tensile strength, suggesting that the tensile properties of 3070LC and 3070LC-P will increase by spinning of precursor fibers with a smaller diameter. Surprisingly, the carbon fibers derived from 3070LC-P seems to perform better than the 3070LC-derived carbon fibers.

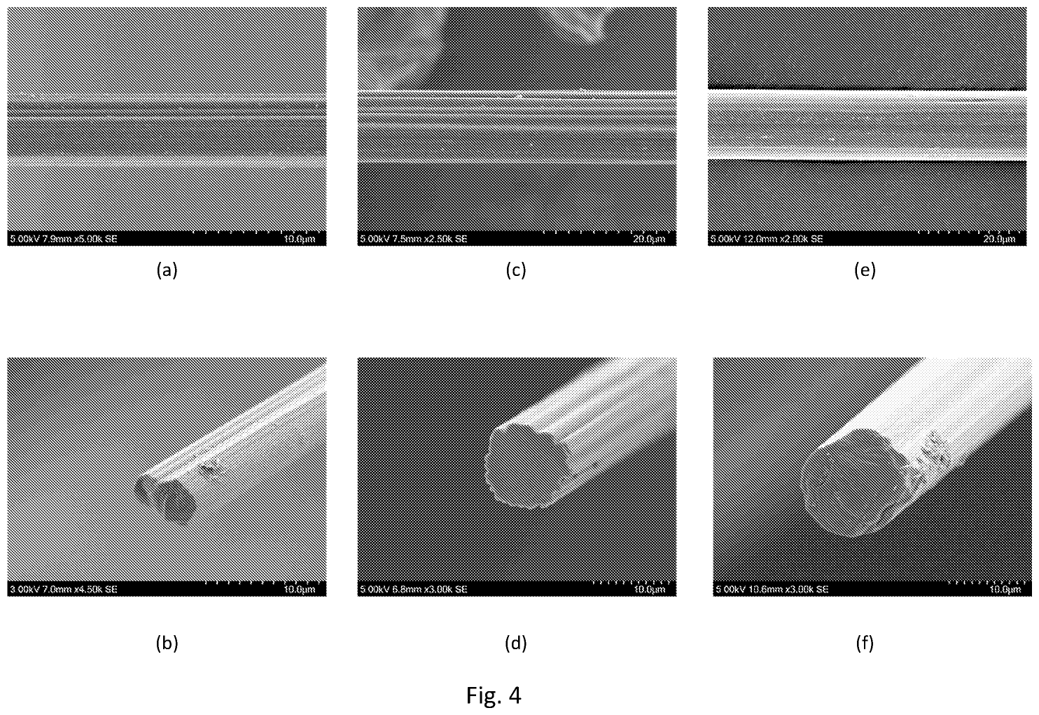

SEM images of the obtained carbon fibers are shown in FIG. 4. Images (a) and (b) are of Example 1 (100C), images (c) and (d) are of Example 2 (3070LC) and images (e) and (f) are of Example 3 (3070LC-P).

A Hitachi SU3500 scanning electron microscope (SEM) operating with a secondary electron (SE) detector and an acceleration voltage of 3-15 kV was used to study the morphology of the carbon fibers. Prior to analysis the carbon fibers were Ag-coated by a 108 auto sputter coater (Cressington Scientific Instruments Ltd., UK) and then placed on a sample holder using double-sided carbon tape. Cross-sections were prepared by snapping the carbon fibers with a scalpel. The carbon fibers have striations that are conserved from the precursor fibers. The cross section of the carbon fibers are solid. In general, it can be stated that the morphology is not changed during conversion of the precursor fibers into carbon fibers. As is the case for the corresponding precursor fibers, the P-containing carbon fiber (Example 3) has less pronounced striations.

1. A method for the production of precursor fiber for the production of carbon fiber, the method for production of precursor fiber comprising the steps:
(a) forming a spinning dope comprising a dissolving pulp, a lignin and an alkali metal hydroxide dissolved in water (s201);
(b) extruding the spinning dope through a spinning nozzle to provide a fibrous extrudate (s203); and
(c) passing the fibrous extrudate through a coagulation liquid to provide the precursor fiber (s205);
wherein the coagulation liquid is arranged to effect precipitation of the precursor fiber by regulation of pH and/or ionicity.

2. The method according to claim 1, wherein the spinning nozzle is submerged in the coagulation liquid.

3. The method according to claim 1,
wherein the coagulation liquid comprises an aqueous solution of sulfuric acid together with sodium sulfate and/or ammonium dihydrogen phosphate,
or
wherein the coagulation liquid comprises an aqueous solution of phosphoric acid and ammonium dihydrogen phosphate.

4. A spinning dope comprising a dissolving pulp, a lignin and an alkali metal hydroxide dissolved in water.

5. The spinning dope according to claim 4, wherein the dissolving pulp has an intrinsic viscosity of 200-400 ml/g, preferably 200-300 ml/g.

6. The spinning dope according to claim 4, wherein the dissolving pulp is a softwood pulp, a softwood kraft pulp, or a hardwood pulp.

7. The spinning dope according to claim 4, wherein the lignin is chosen from LignoBoost lignin, Kraft lignin, soda lignin, organosolv lignin, lignin from cellulosic ethanol production, or mixtures thereof.

8. The spinning dope according to claim 4, further comprising a dope stabilizer selected from zinc oxide, urea and C₂₋₃ polyalkyleneoxide.

9. The spinning dope according to claim 8, wherein the spinning dope comprises from about 0.5% to about 5% by weight of the dope stabilizer relative to the total weight of the spinning dope.

10. The spinning dope according to claim 4, wherein the spinning dope comprises from about 3% to about 7% by weight of dissolving pulp relative to the total weight of the spinning dope.

11. The spinning dope according to claim 4, wherein the ratio of dissolving pulp to lignin in the spinning dope is from about 9:1 to about 1:1 by weight.

12. The spinning dope according to claim 4, wherein the spinning dope comprises from about 6% to about 10% by weight of alkali metal hydroxide relative to the total weight of the spinning dope.

13. A precursor fiber for the production of carbon fiber, the precursor fiber comprising a dissolving pulp and a lignin, wherein the ratio of dissolving pulp to lignin is from about 9:1 to about 1:1 by weight, and wherein the precursor fiber is striated in a longitudinal direction.

14. The precursor fiber according to claim 13, further comprising
from about 500 ppm to about 10000 ppm zinc, and/or
from about 500 ppm to about 5000 ppm phosphorus.

15. A method for the production of carbon fiber, the method comprising the steps:
(a) producing a precursor fiber by the method of claim 1;
(b) optionally stabilizing the precursor fiber by heating to a temperature of from about 200° C. to about 350° C.; and
(c) carbonizing the precursor fiber by heating in an inert atmosphere to a temperature of about 900° C. or higher.

16. (canceled)
